(19) United States
(12) Patent Application Publication
(10) Pub. No.: US 2026/0217332 A1
(43) Pub. Date: Jul. 30, 2026

(54) DRIVE ASSEMBLY FOR A BICYCLE

(71) Applicant: BRP-ROTAX GMBH & CO. KG, Gunskirchen (AT)

(72) Inventors: Gerhard HOFER, Hochneukirchen (AT); Walter HINTERBERGER, Taufkirchen an der Trattnach (AT)

(21) Appl. No.: 19/461,221

(22) Filed: Jan. 27, 2026

Related U.S. Application Data
(60) Provisional application No. 63/751,542, filed on Jan. 30, 2025.

(51) Int. Cl. B62M 6/55; B62M 11/18

(52) U.S. Cl. CPC B62M 6/55; B62M 11/18

(57) ABSTRACT

A drive assembly for a bicycle has: a crankshaft; crank arms; a traction motor operatively connected to the crankshaft; a planet carrier rotating relative to the crankshaft; a first sun or ring gear driven by the crankshaft; at least one first planet gear connected to the planet carrier, the first sun or ring gear engaging and driving the at least one first planet gear; at least one second planet gear rotationally connected to the planet carrier and driven by the at least one first planet gear; a second sun or ring gear rotating relative to the crankshaft, the at least one second planet gear engaging and driving the second sun or ring gear; a drive sprocket driven by the second sun or ring gear; and a control motor operatively connected to the planet carrier for driving the planet carrier about the crankshaft.

### REFERENCE TO RELATED APPLICATION

The present application claims priority from U.S. Provisional Patent Application No. 63/751,542 , filed Jan. 30, 2025, the entirety of which is incorporated herein by reference.

### TECHNICAL FIELD

The present technology relates to drive assemblies for bicycles, and more specifically for bicycles having an electric motor used to assist propulsion.

### BACKGROUND

Following improvements in battery and electric motor technologies, electric bicycles have become an increasingly popular mode of short-distance transportation. Electric bicycles provide the convenient aspects of motor-less bicycles while reducing the effort required by the cyclist to propel the bicycle.

There are diverse types of electric bicycles. One type of electric bicycle is power-on-demand bicycles in which the electric motor is controlled by a “throttle” and can propel the bicycle without the cyclist having to pedal. In a power-on-demand bicycle, the cyclist can also pedal without any assistance from the motor and can pedal while actuating the throttle to provide motorized propulsion assistance. Another type of electric bicycle is pedal-assist bicycles in which an electric motor assists the cyclist's pedal-power without the need to actuate a “throttle.” Pedal-assist bicycles are also known as pedelecs (from pedal electric cycles) or EPACs (Electronically Power Assisted Cycles). For purposes of the present application, the term pedelec will be used. In a pedelec, motorized propulsion assistance is only provided when the cyclist is pedaling and stops when the bicycle reaches a certain speed, such as 25 km/h. Another type of electric bicycle combines the features of power-on-demand bicycles and pedelecs. In other words, a pedelec with a “throttle” that allows the electric motor to propel the bicycle without having to pedal if desired.

In some pedelecs, a derailleur is used to provide a variable-ratio gearing system. The derailleur system is efficient and lightweight. However, the system is exposed to the elements, which could affect its durability and requires regular maintenance. Other pedelecs use gearbox transmission associated with the pedelec's crank. Such gearboxes are heavier than derailleur systems, but are durable, low-maintenance, and provide smooth transition from one gear to another.

However, with derailleur and gearboxes, the shift from one gear to another, even with smooth transitions, can still be felt by the rider of the bicycle. The number of different gear ratios is also limited by the number of sprockets or gears provided.

Therefore, there is a desire for a drive assembly for an electric bicycle that can overcome at least some of the above-described drawbacks.

### SUMMARY

It is an object of the present technology to ameliorate at least some of the inconveniences present in the prior art.

According to one aspect of the present technology, there is provided a drive assembly for a bicycle having: a crankshaft; a pair of crank arms rotationally fixed to the crankshaft for driving the crankshaft; a traction motor operatively connected to the crankshaft for driving the crankshaft; a planet carrier disposed about and coaxial with the crankshaft, the planet carrier rotating relative to the crankshaft; one of a first sun gear and a first ring gear disposed about and coaxial with the crankshaft, the one of the first sun gear and the first ring gear being connected to and driven by the crankshaft; at least one first planet gear rotationally connected to the planet carrier, the at least one first planet gear rotating with the planet carrier relative to the crankshaft, the one of the first sun gear and the first ring gear engaging and driving the at least one first planet gear; at least one second planet gear rotationally connected to the planet carrier, the at least one second planet gear rotating with the planet carrier relative to the crankshaft, the at least one second planet gear being operatively connected to the at least one first planet gear, the at least one first planet gear driving the at least one second planet gear; one of a second sun gear and a second ring gear disposed about and coaxial with the crankshaft, the one of the second sun gear and the second ring gear rotating relative to the crankshaft, the at least one second planet gear engaging and driving the one of the second sun gear and the second ring gear; a drive sprocket disposed about and coaxial with the crankshaft, the drive sprocket rotating relative to the crankshaft, the one of the second sun gear and the second ring gear driving the drive sprocket; and a control motor operatively connected to the planet carrier for driving the planet carrier about the crankshaft.

In some embodiments of the present technology, the drive sprocket is rotationally fixed to the one of the second sun gear and the second ring gear.

In some embodiments of the present technology, the at least one first planet gear and the one of the first sun gear and the first ring gear are disposed: axially between the traction motor and the at least one second planet gear; and axially between the traction motor and the one of the second sun gear and the second ring gear.

In some embodiments of the present technology, the at least one first planet gear, the one of the first sun gear and the first ring gear, the at least one second planet gear, and the one of the second sun gear and the second ring gear are disposed axially between the traction motor and the drive sprocket.

In some embodiments of the present technology, the planet carrier is disposed axially between the at least one first planet gear and the at least one second planet gear.

In some embodiments of the present technology, a diameter of the at least one first planet gear is smaller than a diameter of the at least one second planet gear.

In some embodiments of the present technology, the at least one first planet gear is five first planet gears; and the at least one second planet gear is five second planet gears.

In some embodiments of the present technology, the one of the first sun gear and the first ring gear is the first sun gear; and the one of the second sun gear and the second ring gear is the second sun gear.

In some embodiments of the present technology, a diameter of the first sun gear is larger than a diameter of the second sun gear.

In some embodiments of the present technology, the one of the first sun gear and the first ring gear is the first ring gear; and the one of the second sun gear and the second ring gear is the second ring gear.

In some embodiments of the present technology, an internal diameter of the first ring gear is smaller than an internal diameter of the second ring gear.

In some embodiments of the present technology, at least one shaft is rotationally connected to the planet carrier. The at least one shaft rotates with the planet carrier relative to the crankshaft. The at least one first planet gear is rotationally fixed to the at least one shaft. The at least one second planet gear is rotationally fixed to the at least one shaft. The at least one first planet gear drives the at least one second planet gear via the at least one shaft.

In some embodiments of the present technology, a gear reduction assembly operatively connects the control motor to the planet carrier.

In some embodiments of the present technology, a reduction transmission operatively connects the traction motor to the crankshaft.

In some embodiments of the present technology, the reduction transmission has at least one planetary gear set.

In some embodiments of the present technology, the at least one planetary gear set has: a first planetary gear set connected to and driven by the traction motor; and a second planetary gear set operatively connected between the first planetary gear set and the crankshaft.

In some embodiments of the present technology, the planet carrier is a first planet carrier. The first planetary gear set has: a third sun gear disposed about and coaxial with the crankshaft, the third sun gear rotating relative to the crankshaft, the third sun gear being connected to and driven by the traction motor; a third ring gear disposed about and coaxial with the crankshaft; a second planet carrier disposed about and coaxial with the crankshaft, the second planet carrier rotating relative to the crankshaft; and at least one third planet gear rotationally connected to the second planet carrier, the at least one third planet gear rotating with the second planet carrier relative to the crankshaft, the at least one third planet gear engaging the third sun gear and the third ring gear. The second planetary gear set has: a fourth sun gear disposed about and coaxial with the crankshaft, the fourth sun gear rotating relative to the crankshaft, the fourth sun gear being connected to and driven by the second planet carrier; a fourth ring gear disposed about and coaxial with the crankshaft; a third planet carrier disposed about and coaxial with the crankshaft, the third planet carrier being connected to the crankshaft for driving the crankshaft; and at least one fourth planet gear rotationally connected to the third planet carrier, the at least one fourth planet gear rotating with the third planet carrier relative to the crankshaft, the at least one fourth planet gear engaging the fourth sun gear and the fourth ring gear.

In some embodiments of the present technology, the at least one third planet gear is three third planet gears; and the at least one fourth planet gear is four fourth planet gears.

In some embodiments of the present technology, the third ring gear and the fourth ring gear are rotationally fixed.

In some embodiments of the present technology, the third ring gear and the fourth ring gear are a common ring gear.

In some embodiments of the present technology, the drive assembly also has a controller for controlling power applied to the traction motor and power applied to the control motor.

In some embodiments of the present technology, the controller is configured to control the power applied to the traction motor based at least on: a speed of rotation of the crankshaft; a speed of rotation of the control motor; and the power applied to the control motor.

According to another aspect of the present technology, there is provided a bicycle having: a frame; a front wheel rotationally connected to the frame; a rear wheel rotationally connected to the frame; a driven sprocket operatively connected to the rear wheel for driving the rear wheel; the drive assembly according to the above connected to the frame; a flexible drive member operatively connecting the drive sprocket to the driven sprocket; and a battery pack electrically connected to the traction motor and to the control motor.

In the context of the present specification, unless expressly provided otherwise, the words “first,” “second”, “third”, etc. have been used as adjectives only for the purpose of allowing for distinction between the nouns that they modify from one another, and not for the purpose of describing any particular relationship between those nouns.

It must be noted that, as used in this specification and the appended claims, the singular form “a,” “an” and “the” include plural referents unless the context clearly dictates otherwise.

As used herein, the term “about” in the context of a given value or range refers to a value or range that is within 20%, preferably within 10%, and more preferably within 5% of the given value or range.

As used herein, the term “and/or” is to be taken as specific disclosure of each of the two specified features or components with or without the other. For example, “A and/or B” is to be taken as specific disclosure of each of (i) A, (ii) B and (iii) A and B, just as if each is set out individually herein.

For purposes of the present application, terms related to spatial orientation when referring to a bicycle and components in relation to the bicycle, should be understood as they would be understood by a rider of the bicycle sitting thereon in a normal riding position with the bicycle steered straight-ahead and being at rest on flat, level ground.

Embodiments of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects, and advantages of embodiments of the present technology will become apparent from the following description, the accompanying drawings, and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a right side elevation view of a pedelec according to the present technology;

FIG. 2 is a perspective view taken from a front, right side of components of a drive assembly of the pedelec of FIG. 1;

FIG. 3 is an exploded perspective view taken from a front, right side of components of a drive transmission of the drive assembly of FIG. 2;

FIG. 4 is a schematic representation of the drive assembly of FIG. 2, with a housing being omitted;

FIG. 5 is an exploded perspective view taken from a front, right side of components of a reduction transmission of the drive assembly of FIG. 2;

FIG. 6 is a schematic representation of the reduction transmission of FIG. 5; and

FIG. 7 is a schematic representation of an alternative embodiment of the drive assembly of FIG. 2, with a housing being omitted.

### DETAILED DESCRIPTION

The present disclosure is not limited in its application to the details of construction and the arrangement of components set forth in the following description or illustrated in the drawings. The disclosure is capable of other embodiments and of being practiced or of being carried out in various ways. Also, the phraseology and terminology used herein are for the purpose of description and should not be regarded as limiting. The use of “including”, “comprising”, “having”, “containing”, “involving” and variations thereof herein, is meant to encompass the items listed thereafter as well as, optionally, additional items. In the following description, the same numerical references refer to similar elements.

The present technology will be described with reference to a pedelec 10. It is contemplated that aspects of the present technology could be applied to other types of electric bicycles, such as power-on-demand bicycles or combination pedelec/power-on-demand bicycles.

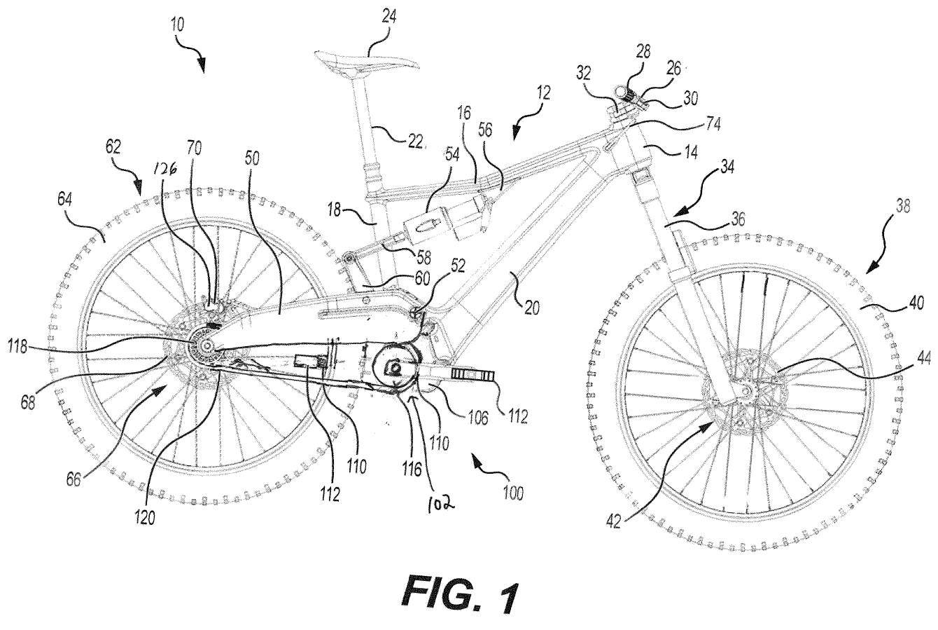

With reference to FIG. 1, the pedelec 10 has a frame 12. The frame 12 has a head tube 14, a top tube 16, a seat tube 18, and a down tube 20. As can be seen, the top tube 16, the seat tube 18 and the down tube 20 form a generally triangular shape. The seat tube 18 receives a seat post 22 therein. A saddle 24 is connected to a top of the seat post 22. The seat post 22 is selectively slidable in the seat tube 18 to adjust a height of the saddle 24. A clamp (not shown) is used to fix the seat post 22 in the desired position.

A handlebar 26 is pivotally connected to the head tube 14. The handlebar 26 has left and right hand grips 28 (only the right one being shown). Left and right brake levers 30 (only the right one being shown) are mounted to the handlebar 26 in proximity to the left and right hand grips 28, respectively, in front of the handlebar 26. A shifter 32 is pivotally connected to the handlebar 26 in proximity to the right hand grip 28. The shifter 32 extends partially rearward of the right hand grip 28. As such, the shifter 32 can be actuated by a thumb of a right hand of a cyclist riding the pedelec 10. It is contemplated that the shifter 32 could alternatively be provided in proximity to the left hand grip 28. In the present embodiment, the shifter 32 is used to upshift and downshift, but it is contemplated that the pedelec 10 could have one shifter to upshift and one shifter to downshift. These two shifters could be provided in proximity to the same hand grip 28 or there could be one shifter provided in proximity to each hand grip 28. It is also contemplated that in some embodiments, the shifter 32 could be replaced by a different type of shifter, such as a twist grip. It is contemplated that in some embodiments, the shifter 32 could be omitted.

A fork 34 is connected to the handlebar 26 below the head tube 14. The fork 34 includes a pair of front shock absorbers 36. It is contemplated that in some embodiments, the front shock absorbers 36 could be omitted. A front wheel 38 is rotationally connected to the fork 34. The fork 34 and the front wheel 38 pivot with the handlebar 26 to steer the pedelec 10. The front wheel 38 has a threaded tire 40 of the type typically found on mountain bikes, but other types of tires are contemplated. The front shock absorbers 36 allow the front wheel 38 to travel up and down, such as when going over bumpy terrain. A front brake assembly 42 is mounted to the front wheel 38. The front brake assembly 42 includes a brake disc 44 and a brake caliper (not shown). The brake caliper is actuated by a hydraulic line (not shown) connected to the left brake lever 30. This hydraulic line passes through the frame 12. It is contemplated that instead of being a disc brake assembly, the front brake assembly 42 could be another type of brake assembly, such as a rim brake assembly or a drum brake assembly, for example. It is also contemplated that instead of being hydraulically actuated, the disc brake assembly 42 could be actuated mechanically (e.g., via push-pull cable) or electrically, for example.

Left and right chain stays 50 (only the right one being shown) are pivotally connected to the left and right sides of the frame 12 about a pivot axis 52. A rear shock absorber 54 is pivotally connected between tabs 56 extending downward from the top tube 16. A yoke 58 is connected to the rear shock absorber 54. The seat tube 18 is disposed between the legs of the yoke 58. The ends of the legs of the yoke 58 are connected to left and right arms 60 (only the right one being shown). The lower ends of the left and right arms 60 are connected to the inner sides of the left and right chain stays 50, respectively. It is contemplated that in some embodiments, the rear shock absorber 54, the yoke 58, and the arms 60 could be omitted. In such an embodiment, the chain stays 50 are fixedly connected to the frame 12, and the frame 12 includes left and right seat stays connected between the upper end of the seat tube 18 and the rear ends of the chain stays 50.

A rear wheel 62 is disposed between the chain stays 50 and is rotationally connected thereto. The rear wheel 62 has a threaded tire 64 of the type typically found on mountain bikes, but other types of tires are contemplated. The rear shock absorber 54 allows the rear wheel 62 to travel up and down by pivoting with the chain stays 50 about the pivot axis 52, such as when going over bumpy terrain. A rear brake assembly 66 is mounted to the rear wheel 62. The rear brake assembly 66 includes a brake disc 68 and a brake caliper 70. The brake caliper 70 is mounted to a bracket (not shown) defined by the left chain stay 50. The brake caliper 70 is actuated by a hydraulic line 74 connected to the right brake lever 30. From the right brake lever 30, the hydraulic line 74 passes through the down tube 20 of the frame 12 and then passes along the inner side of the left chain stay 50 and then connects to the caliper 70. It is contemplated that instead of being a disc brake assembly, the rear brake assembly 66 could be another type of brake assembly, such as a rim brake assembly or a drum brake assembly, for example. It is also contemplated that instead of being hydraulically actuated, the disc brake assembly 66 could be actuated mechanically (e.g., via push-pull cable) or electrically, for example.

The pedelec 10 is propelled by a powertrain 100. With reference to FIGS. 1, 2, and 4, the powertrain 100 includes a drive assembly 102. The drive assembly 102 has a traction motor 104 and a control motor 105 disposed in a housing 106. The traction motor 104 and the control motor 105 are electric motors. The housing 106 is connected to the lower ends of the seat tube 18 and the down tube 20 of the frame 12. The drive assembly 102 also has a crankshaft 108 that extends through the housing 106 and a pair of crank arms 110 rotationally fixed to the ends of the crankshaft 108. Pedals 112 are rotationally connected to the ends of the crank arms 110. The drive assembly 102 has a drive sprocket 116. A driven sprocket 118 is rotationally fixed to the rear wheel 62. A flexible drive member 120 wraps around and engages the drive and driven sprockets 116, 118 to transmit torque from the drive sprocket 116 to the driven sprocket 118. In the present embodiment, the flexible drive member 120 is a chain 120, and the drive and driven sprockets 116, 118 are chain sprockets. It is contemplated that in other embodiments, the flexible drive member 120 could be a toothed drive belt, and the sprockets 116, 118 could be belt sprockets. It is contemplated that a chain tensioner could be provided near the drive sprocket 116 or the driven sprocket 118. The drive assembly 102 will be described in more detail below.

The traction motor 104 and the control motor 105 are electrically connected to a battery pack 122 via a controller 124. The battery pack 122 is disposed in the down tube 20 of the frame 12 and is connected to the frame 12. The battery pack 122 is inserted through the bottom of the down tube 20 before the housing 106 is mounted to the frame 12. The battery pack 122 has multiple lithium-ion batteries, such as Samsung™ 40T batteries. It is contemplated that the batteries could be of a different type.

To recharge the battery pack, a magnetic charging connector (not shown) is connected to the frame 12 between the lower ends of the seat tube 18 and the down tube 20. The connector is electrically connected to the controller 124. In some embodiments, the connector also permits the exchange of data with the controller 124 for diagnostic and/or programming purposes.

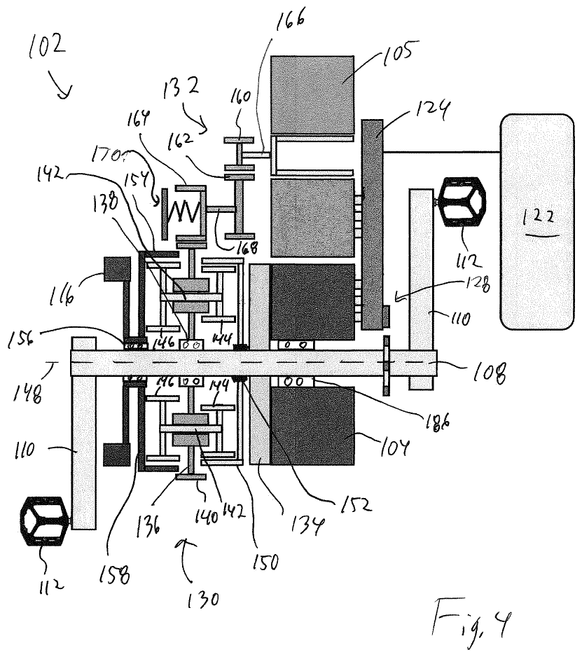

A speed sensor 126 (FIG. 1) senses a speed of rotation of the rear wheel 62 and sends a signal indicative of a speed of the pedelec 10 to the controller 124. A speed sensor 128 (FIG. 4) senses a speed of rotation of the crankshaft 108 and sends a signal indicative of this speed, called cadence, to the controller 124. In the present embodiment, the speed sensors 126, 128 are Hall effect sensors, but other types of speed sensors are contemplated.

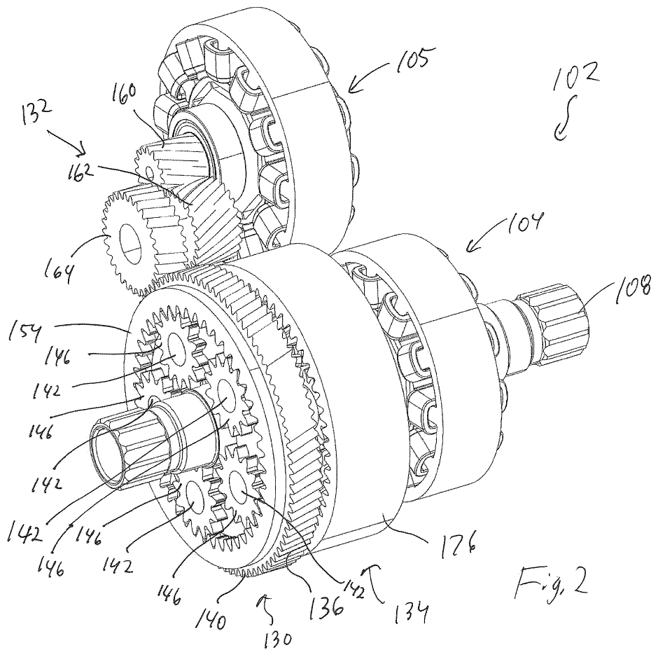

Turning now to FIGS. 2 to 6, the drive assembly 102 will be described in more detail. As indicated above, the drive assembly 102 includes the traction motor 104, the control motor 105, the housing 106, the crankshaft 108, the crank arms 110, the pedals 112, the drive sprocket 116, and the controller 124. The drive assembly 102 also includes a drive transmission 130, a gear reduction assembly 132, and a reduction transmission 134. The reduction transmission 134 is disposed between the drive transmission 130 and the traction motor 104. The drive transmission 130 is disposed between the drive sprocket 116 and the reduction transmission 134. The traction motor 104, the control motor 105, the controller 124, the drive transmission 130, the gear reduction assembly 132, and the reduction transmission 134 are disposed inside the housing 106. The crankshaft 108 extends through the traction motor 104, the housing 106, the drive transmission 130, and the reduction transmission 134 and is rotationally supported by the housing 106. The ends of the crankshaft 108, the crank arms 110, the pedals 112, and the drive sprocket 116 are disposed outside the housing 106.

A cyclist riding the pedelec 10 with their feet on the pedals 112 drives the crank arms 110 by pedaling, which causes the crank arms 110 to drive the crankshaft 108. The traction motor 104 drives the reduction transmission 134, and the reduction transmission 134 drives the crankshaft 108. The crankshaft 108 drives the drive transmission 130 by transmitting the torque from the crank arms 110 and the traction motor 104, via the reduction transmission 134, to the drive transmission 130. The drive transmission 130 drives the drive sprocket 116, which in turn drives the rear wheel 62 via the flexible drive member 120 and the driven sprocket 118. The control motor 105 drives the gear reduction assembly 132, which in turn drives a component of the drive transmission 130, as will be described in more detail below, to control a transmission ratio of the drive transmission 130.

In the present embodiment, the traction motor 104 and the control motor 105 are identical, but it is contemplated that they could be different from each other. The controller 124 receives electric power from the battery pack 122 and distributes the electric power to the traction motor 104 and the control motor 105 based on different inputs as will be described in greater detail below. In some embodiments, the controller 124 can also receive electric power from the control motor 105 operating in a generator mode and distribute this power to the battery pack 122 to recharge the battery pack 122. Although the controller 124 is illustrated as a single unit in FIG. 4, it should be understood that the controller 124 could be made up of multiple distinct units, with each unit being responsible for controlling one or more aspects of the operation of the pedelec 10, and more specifically, of the drive assembly 102.

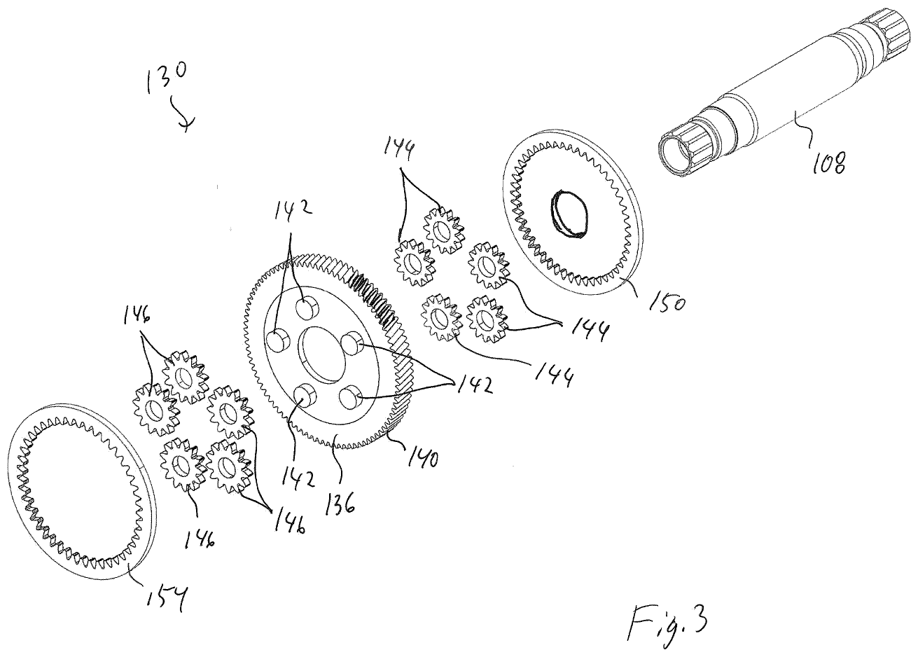

With reference to FIGS. 3 and 4, the drive transmission 130 will now be described in more detail. A planet carrier 136 is disposed about and is coaxial with the crankshaft 108. The planet carrier 136 is connected to the crankshaft 108 by a ball bearing 138, or another type of bearing, to allow the planet carrier 136 to rotate relative to the crankshaft 108. As best seen in FIG. 3, a circumference 140 of the planet carrier 136 has helical teeth, such that the planet carrier 136 is a gear that is engaged by the gear reduction assembly 132 as will be described below. Five shafts 142 extend through and are rotationally connected to the planet carrier 136. Although not shown, the shafts 142 are supported by bearings, such as journal bearings. Five planet gears 144 are rotationally fixed to the ends of the five shafts 142 on one side of the planet carrier 136. Five planet gears 146 are rotationally fixed to the opposite ends of the five shafts 142 on the other side of the planet carrier 136. As such, the planet carrier 136 is axially between the planet gears 144 and the planet gears 146 with respect to a longitudinal axis 148 of the crankshaft 108. The shafts 142 rotationally connect the planet gears 144, 146 to the planet carrier 136, and the planet gears 144, 146 rotate with the planet carrier 136 relative to the crankshaft 108. The planet gears 144 drive their corresponding planet gears 146 via the shafts 142. A diameter of the planet gears 144 is smaller than a diameter of the planet gears 146. However, it is contemplated that the planet gears 144 and the planet gears 146 could have the same diameter, or that the planet gears 144 could have a larger diameter than the planet gears 146. It is also contemplated that there could be more or less than five planet gears 144, in which case there would be a corresponding number of shafts 142 and planet gears 146.

The drive transmission 130 also has a ring gear 150 that is disposed about and is coaxial with the crankshaft 108. The ring gear 150 is connected to the crankshaft 108 by a freewheel 152, such that the ring gear 150 can be driven by the crankshaft 108, but the ring gear 150 cannot drive the crankshaft 108. As such, should the pedelec 10 be in motion and the cyclist decide to stop pedaling, the rotation of the drive sprocket 116 will not be transmitted to the crankshaft 108, and the pedals 112 can remain stationary. The ring gear 150 is disposed axially between the reduction transmission 134 and the planet gears 144. As such, the planet gears 144 and the ring gear 150 are disposed axially between the traction motor 104 and the planet gears 146. The ring gear 150 engages and drives the planet gears 144, which in turn drive the planet gears 146 as described above.

The drive assembly 102 has another ring gear 154 disposed about and coaxial with the crankshaft 108 on the opposite side of the planet carrier 136. As such, the planet gears 144 and the ring gear 150 are disposed axially between the traction motor 104 and the ring gear 154. The ring gear 154 is connected to the crankshaft 108 by a ball bearing 156, or another type of bearing, to allow the ring gear 154 to rotate relative to the crankshaft 108. The planet gears 146 engage and drive the ring gear 154. An internal diameter of the ring gear 150 is smaller than an internal diameter of the ring gear 154. However, it is contemplated that the ring gear 150 and the ring gear 154 could have the same internal diameter, or that the ring gear 150 could have a larger internal diameter than the ring gear 154.

The drive sprocket 116 is disposed about and is coaxial with the crankshaft 108. The drive sprocket 116 is rotationally fixed to the ring gear 154 by a member 158. As such, the ring gear 154 drives the drive sprocket 116 via the member 158, and the ring gear 154, the drive sprocket 116, and the member 158 rotate together. The drive sprocket 116 and the member 158 are connected to the crankshaft 108 by the ball bearing 156 to allow the drive sprocket 116 and the member 158 to rotate relative to the crankshaft 108. It is contemplated that, instead of being rotationally supported by the bearing 156, a separate bearing could be provided for rotationally supporting the drive sprocket 116 and the member 158. The drive sprocket 116 is disposed axially outward of the ring gear 154. As such, the planet carrier 136, the planet gears 144, the planet gears 146, the ring gear 150, and the ring gear 154 are disposed axially between the traction motor 104 and the drive sprocket 116.

With reference to FIGS. 2 and 4, the gear reduction assembly 132 will now be described in more detail. The gear reduction assembly 132 operatively connects the control motor 105 to the planet carrier 136 such that the control motor 105 can drive the planet carrier 136 about the crankshaft 108. The gear reduction assembly 132 has three helical gears 160, 162, 164. The gear 160 is connected to and driven by an output shaft 166 that is driven by the control motor 105. The gear 160 engages and drives the gear 162. The gears 162, 164 are coaxial and are connected to a shaft 168. As such, the gear 162 drives the gear 164 via the shaft 168. The gear 164 engages and drives the circumference 140 of the planet carrier 136, and thereby drives the planet carrier 136 about the crankshaft 108. A brake 170 connects the gear 164 to the shaft 168 to limit the torque transfer between the control motor 105 and the planet carrier 136. It is contemplated that the brake 170 could be omitted. It is also contemplated that the brake 170 could be replaced by a brake used to block the gear 164 when a torque limit is exceeded. It is contemplated that the gear reduction assembly 132 could be different from the one described above. For example, the gear reduction assembly 132 could instead be a planetary gear assembly. It is also contemplated that the gear 164 and the toothed circumference 140 of the planet carrier 136 could be replaced by a belt and pulleys.

By modifying the speed at which the control motor 105 drives the planet carrier 136 about the crankshaft 108, the transmission ratio provided by the drive transmission 130 between the crankshaft 108 and the drive sprocket 116 is modified. By increasing the speed of rotation of the planet carrier 136, the transmission ratio (crankshaft speed over drive sprocket speed) provided by the drive transmission 130 decreases. By decreasing the speed of rotation of the planet carrier 136, the transmission ratio provided by the drive transmission 130 increases. Since the speed of rotation of the control motor 105 can be modified continuously, the transmission ratio provided by the drive transmission 130 can also be modified continuously. This is known as stepless adjustment of the transmission ratio. As such, the cyclist does not feel gear shifts as they would with a derailleur system, for example. In some embodiments, one version of which will be described in detail below, the controller 124 automatically controls the speed of rotation of the control motor 105 to adjust the transmission ratio of the drive transmission 130. In the present embodiment, the controller 124 can also simulate discrete transmission ratios similar to those that would be provided by a derailleur system. This is achieved by having the controller 124 rapidly change the speed of the control motor 105 from one speed to another in response to actuation of the shifter 32 by the cyclist.

As previously mentioned, the control motor 105 can operate as a generator for recharging the battery pack 122. The present embodiment of the drive transmission 130, in particular the location of the freewheel 152, makes this possible. With the pedelec 10 in motion, should the cyclist stop pedaling or reduce the cadence below the speed that would be needed to maintain the current speed of the pedelec 10, the freewheel 152 will cause the ring gear 150 to rotate relative to the crankshaft 108. As such, instead of having the crankshaft 108 drive the drive transmission 130, it is the rotation of the rear wheel 62 that drives the drive transmission 130. More specifically, the rear wheel 62 drives the driven sprocket 118, which drives the drive sprocket 116 via the flexible drive member 120; the drive sprocket 116 drives the ring gear 154, which drives the planet gears 146; the planet gears 146 drive the planet carrier 136 and the planet gears 144; and the planet gears 144 drive the ring gear 150. Due to the presence of the freewheel 152, the ring gear 150 does not drive the crankshaft 108. The rotation of the planet carrier 136 is transferred to the control motor 105 via the gear reduction assembly 132, thereby causing the control motor 105 to operate as a generator. The electricity generated by the control motor 105 is transferred to the battery pack 122 via the controller 124. It is contemplated that instead of having the freewheel 152 between the ring gear 150 and the crankshaft 108, it could be provided between the drive sprocket 116 and the ring gear 154, or between the driven sprocket 118 and the rear wheel 62; however, such arrangements would not permit the operation of the control motor 105 as a generator.

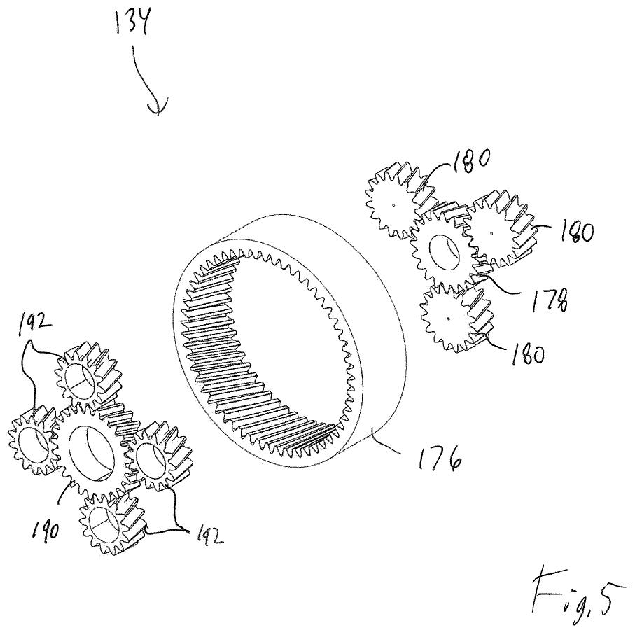

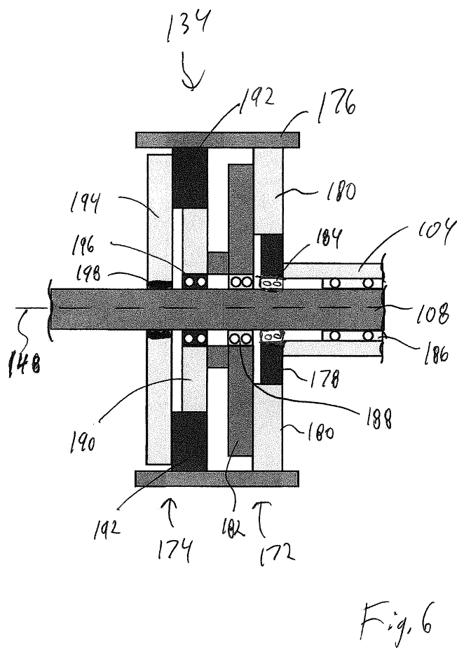

Turning now to FIGS. 5 and 6, the reduction transmission 134 of the drive assembly 102 will be described in detail. The reduction transmission 134 has a planetary gear set 172 connected to and driven by the traction motor 104 and a planetary gear set 174 operatively connected between the planetary gear set 172 and the crankshaft 108. In an alternative embodiment, the reduction transmission 134 has a single planetary gear set operatively connected between the traction motor 104 and the crankshaft 108. It is contemplated that the reduction transmission 134 could be a type of transmission that does not have a planetary gear set or combines one or more planetary gear sets with another type of drive mechanism.

In the present embodiment, the planetary gear sets 172, 174 have a common ring gear 176. The ring gear 176 is disposed about and is coaxial with the crankshaft 108. In the present embodiment, the ring gear 176 is rotationally fixed. It is contemplated that instead of having a common ring gear 176, each planetary gear set 172, 174 could have a distinct ring gear.

In addition to the ring gear 176, the planetary gear set 172 has a sun gear 178, three planet gears 180, and a planet carrier 182. The sun gear 178 is disposed about and is coaxial with the crankshaft 108. The sun gear 178 is connected to the crankshaft 108 by a ball bearing 184, or another type of bearing, to allow the sun gear 178 to rotate relative to the crankshaft 108. The sun gear 178 is connected to and driven by the traction motor 104. As can be seen, the traction motor 104 is rotationally supported on the crankshaft 108 by a ball bearing 186, or another type of bearing. The planet carrier 182 is disposed about and is coaxial with the crankshaft 108. The planet carrier 182 is connected to the crankshaft 108 by a ball bearing 188, or another type of bearing, to allow the planet carrier 182 to rotate relative to the crankshaft 108. The three planet gears 180 are rotationally connected to the planet carrier 182. The three planet gears 180 rotate with the planet carrier 182 relative to the crankshaft 108. The planet gears 180 engage the sun gear 178 and the ring gear 176. It is contemplated that the planetary gear set 172 could have more or less than three planet gears 180.

In addition to the ring gear 176, the planetary gear set 174 has a sun gear 190, four planet gears 192, and a planet carrier 194. The sun gear 190 is disposed about and is coaxial with the crankshaft 108. The sun gear 190 is connected to the crankshaft 108 by a ball bearing 196, or another type of bearing, to allow the sun gear 190 to rotate relative to the crankshaft 108. The sun gear 190 is connected to and driven by the planet carrier 182. The planet carrier 194 is disposed about and is coaxial with the crankshaft 108. The planet carrier 194 is connected to the crankshaft 108 by a freewheel 198, such that the planet carrier 194 can drive the crankshaft 108, but the planet carrier 194 cannot be driven by the crankshaft 108. The four planet gears 192 are rotationally connected to the planet carrier 194. The four planet gears 192 rotate with the planet carrier 194 relative to the crankshaft 108. The planet gears 192 engage the sun gear 190 and the ring gear 176. It is contemplated that the planetary gear set 174 could have more or less than four planet gears 192.

When the controller 124 operates the traction motor 104, the traction motor 104 drives the sun gear 178, the sun gear 178 drives the planet gears 180, the planet gears 180 drive the planet carrier 182, the planet carrier 182 drives the sun gear 190, the sun gear 190 drives the planet gears 192, the planet gears 192 drive the planet carrier 194, and the planet carrier 194 drives the crankshaft 108. As such, by operating the traction motor 104, the drive assembly 102 assists the cyclist in propelling the pedelec 10.

One method of controlling the traction motor 104 and the control motor 105 by the controller 124 will now be described. The controller 124 determines the speed of rotation of the crankshaft 108 (i.e., cadence) from the signal received from the speed sensor 128. Based on the cadence, the controller 124 applies electric power from the battery pack 122 to the control motor 105 to operate the control motor 105 at a corresponding desired speed. The speed correspondence can be obtained from one or more lookup tables stored in the controller 124 or can be calculated in real time by the controller 124 or from a combination of both. The current speed of the control motor 105 can be determined by the controller 124 from a speed sensor (not shown) built-in the control motor 105 or a speed sensor (not shown) sensing a speed of rotation of any one of the gears 160, 162, 164, the output shaft 166, the shaft 168, or the planet carrier 136. Then, based on the cadence and the amount of electric power supplied to the control motor 105 in order to obtain the desired speed of the control motor 105, the controller 124 can determine the amount of torque applied to the crankshaft 108 by the cyclist, hereinafter referred to as bio-torque. In making this determination, the controller 124 also considers other factors such as the efficiency of the drive transmission 130, temperature, and the transmission ratio of the drive assembly 102. As described above, the transmission ratio of the drive assembly 102 corresponds to the crankshaft speed (cadence) over the drive sprocket speed. The speed of the drive sprocket 116 can be determined by the controller 124 from the signal received from the speed sensor 126 since the gear ratio between the drive sprocket and the driven sprocket 118 is fixed. The speed of the drive sprocket 116 could alternatively be determined from a speed of the pedelec 10 or from a speed sensor sensing a speed or rotation of the drive sprocket 116, the member 158, or the ring gear 154. The bio-torque can be obtained from one or more lookup tables stored in the controller 124 or can be calculated in real time by the controller 124 or from a combination of both. With the bio-torque having been determined, the controller 124 can determine the amount of torque to be applied by the traction motor 104. This amount of torque corresponds to a percentage of the bio-torque. The percentage can be a fixed percentage or can be set by the cyclist via an input such as buttons, levers, a touchscreen, or wirelessly via a smartphone for example. A cyclist wanting more propulsion assistance from the traction motor 104 sets a higher percentage of the bio-torque. It is contemplated that instead of setting a percentage, the cyclist could select discrete levels of assistance (i.e., 1, 2, 3, 4, or low, medium, high), each of which corresponds to a predefined percentage of the bio-torque. With the torque to be applied by the traction motor 104 having been determined, the controller 124 determines the amount of power to be applied to the traction motor 104 from the battery pack 122 and applies it to the traction motor 104. This method is repeated in a loop during operation of the pedelec 10, such that the controller 124 is continuously controlling the power applied to the traction motor 104 and the control motor 105. As will be noted, the above method does not require the use of a torque sensor, which would add cost and take valuable space inside the housing 106.

It is contemplated that the controller 124 could stop powering the traction motor 104 when the pedelec 10 exceeds a predetermined speed, such as 25 km/h or 32 km/h. It is also contemplated that the controller 124 could stop powering the traction motor 104 when the cyclist riding the pedelec 10 is not pedaling.

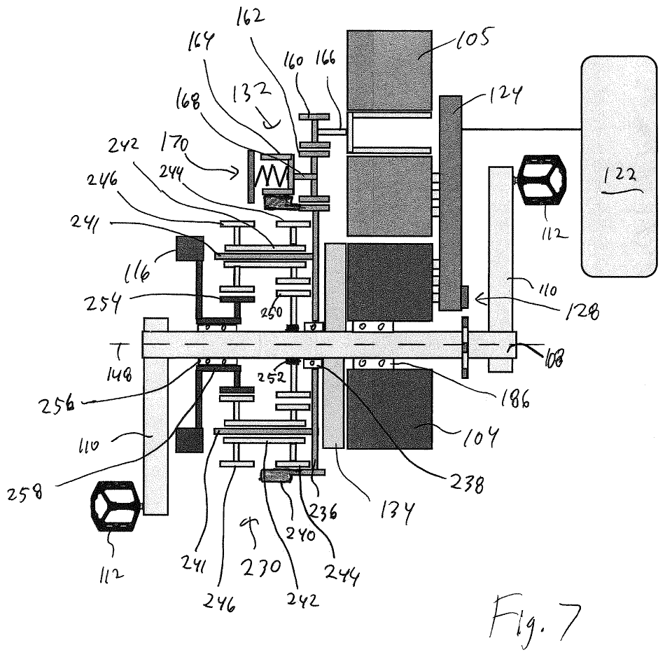

Turning now to FIG. 7, a drive assembly 202 will be described. The drive assembly 202 is an alternative embodiment of the drive assembly 102. In the drive assembly 202, the drive transmission 130 has been replaced by a drive transmission 230, but the other components are the same as those of the drive assembly 102. As such, components of the drive assembly 202 that correspond to those of the drive assembly 102 have been numbered with the same reference numerals in FIG. 7 and will not be described again in detail.

The drive transmission 230 has a planet carrier 236 disposed about and coaxial with the crankshaft 108. The planet carrier 236 is connected to the crankshaft 108 by a ball bearing 238, or another type of bearing, to allow the planet carrier 236 to rotate relative to the crankshaft 108. A circumference 240 of the planet carrier 236 is toothed, such that the planet carrier 236 is a gear that is engaged by the gear 164 of the gear reduction assembly 132. Five rods 241 extend axially outward from the planet carrier 236. Five hollow shafts 242 are rotationally supported on the five rods 241. Although not shown, the shafts 242 are supported on the rods 241 by bearings such as journal bearings. Five planet gears 244 are rotationally fixed to the ends of the five shafts 242 that are closest to the planet carrier 236. Five planet gears 246 are rotationally fixed to the opposite ends of the five shafts 242. As such, the planet gears 244 are disposed axially between the planet carrier 236 and the planet gears 246 with respect to the longitudinal axis 148 of the crankshaft 108. The shafts 242 rotationally connect the planet gears 244, 246 to the planet carrier 236, and the planet gears 244, 246 rotate with the planet carrier 236 relative to the crankshaft 108. The planet gears 244 drive their corresponding planet gears 246 via the shafts 242. A diameter of the planet gears 244 is smaller than a diameter of the planet gears 246. However, it is contemplated that the planet gears 244 and the planet gears 246 could have the same diameter, or that the planet gears 244 could have a larger diameter than the planet gears 246. It is also contemplated that there could be more or less than five planet gears 244, in which case there would be a corresponding number of rods 241, shafts 242, and planet gears 246.

The drive transmission 230 also has a sun gear 250 that is disposed about and is coaxial with the crankshaft 108. The sun gear 250 is connected to the crankshaft 108 by a freewheel 252 such that the sun gear 250 can be driven by the crankshaft 108, but the sun gear 250 cannot drive the crankshaft 108. As such, should the pedelec 10 be in motion and the cyclist decides to stop pedaling, the rotation of the drive sprocket 116 will not be transmitted to the crankshaft 108 and the pedals 112 can remain stationary. The sun gear 250 is disposed axially between the planet carrier 236 and the planet gears 246. The planet carrier 236 is disposed axially between the traction motor 104 and the sun gear 250. The sun gear 250 engages and drives the planet gears 244, which in turn drive the planet gears 246 as described above.

The drive assembly 202 has another sun gear 254 disposed about and coaxial with the crankshaft 108 in axial alignment with the planet gears 246. As such, the planet gears 244 and the sun gear 250 are disposed axially between the traction motor 104 and the sun gear 254. The sun gear 254 is connected to the crankshaft 108 by a ball bearing 256, or another type of bearing, to allow the sun gear 254 to rotate relative to the crankshaft 108. The planet gears 246 engage and drive the sun gear 254. A diameter of the sun gear 250 is larger than a diameter of the sun gear 254. However, it is contemplated that the sun gear 250 and the sun gear 254 could have the same diameter, or that the sun gear 250 could have a smaller diameter than the sun gear 254.

The drive sprocket 116 is rotationally fixed to the sun gear 254 by a member 258. As such, the sun gear 254 drives the drive sprocket 116 via the member 258, and the sun gear 254, the drive sprocket 116, and the member 258 rotate together. The drive sprocket 116 and the member 258 are connected to the crankshaft 108 by the ball bearing 256 to allow the drive sprocket 116 and the member 258 to rotate relative to the crankshaft 108. It is contemplated that instead of being rotationally supported by the bearing 256, a separate bearing could be provided for rotationally supporting the drive sprocket 116 and the member 258. The drive sprocket 116 is disposed axially outward of the sun gear 254. As such, the planet carrier 236, the planet gears 244, the planet gears 246, the sun gear 250, and the sun gear 254 are disposed axially between the traction motor 104 and the drive sprocket 116.

Modifications and improvements to the above-described embodiments of the present invention may become apparent to those skilled in the art. The foregoing description is intended to be exemplary rather than limiting. The scope of the present invention is therefore intended to be limited solely by the appended claims.

What is claimed is:

1. A drive assembly for a bicycle comprising:
a crankshaft;
a pair of crank arms rotationally fixed to the crankshaft for driving the crankshaft;
a traction motor operatively connected to the crankshaft for driving the crankshaft;
a planet carrier disposed about and coaxial with the crankshaft, the planet carrier rotating relative to the crankshaft;
one of a first sun gear and a first ring gear disposed about and coaxial with the crankshaft, the one of the first sun gear and the first ring gear being connected to and driven by the crankshaft;
at least one first planet gear rotationally connected to the planet carrier, the at least one first planet gear rotating with the planet carrier relative to the crankshaft,
the one of the first sun gear and the first ring gear engaging and driving the at least one first planet gear;
at least one second planet gear rotationally connected to the planet carrier, the at least one second planet gear rotating with the planet carrier relative to the crankshaft,
the at least one second planet gear being operatively connected to the at least one first planet gear, the at least one first planet gear driving the at least one second planet gear;
one of a second sun gear and a second ring gear disposed about and coaxial with the crankshaft, the one of the second sun gear and the second ring gear rotating relative to the crankshaft,
the at least one second planet gear engaging and driving the one of the second sun gear and the second ring gear;
a drive sprocket disposed about and coaxial with the crankshaft, the drive sprocket rotating relative to the crankshaft,
the one of the second sun gear and the second ring gear driving the drive sprocket; and
a control motor operatively connected to the planet carrier for driving the planet carrier about the crankshaft.

2. The drive assembly of claim 1, wherein the drive sprocket is rotationally fixed to the one of the second sun gear and the second ring gear.

3. The drive assembly of claim 1, wherein the at least one first planet gear and the one of the first sun gear and the first ring gear are disposed:
axially between the traction motor and the at least one second planet gear; and
axially between the traction motor and the one of the second sun gear and the second ring gear.

4. The drive assembly of claim 1, wherein the at least one first planet gear, the one of the first sun gear and the first ring gear, the at least one second planet gear, and the one of the second sun gear and the second ring gear are disposed axially between the traction motor and the drive sprocket.

5. The drive assembly of claim 1, wherein the planet carrier is disposed axially between the at least one first planet gear and the at least one second planet gear.

6. The drive assembly of claim 1, wherein a diameter of the at least one first planet gear is smaller than a diameter of the at least one second planet gear.

7. The drive assembly of claim 1, wherein:
the at least one first planet gear is five first planet gears; and
the at least one second planet gear is five second planet gears.

8. The drive assembly of claim 1, wherein:
the one of the first sun gear and the first ring gear is the first sun gear; and
the one of the second sun gear and the second ring gear is the second sun gear.

9. The drive assembly of claim 8, wherein a diameter of the first sun gear is larger than a diameter of the second sun gear.

10. The drive assembly of claim 1, wherein:
the one of the first sun gear and the first ring gear is the first ring gear; and
the one of the second sun gear and the second ring gear is the second ring gear.

11. The drive assembly of claim 10, wherein an internal diameter of the first ring gear is smaller than an internal diameter of the second ring gear.

12. The drive assembly of claim 1, further comprising at least one shaft rotationally connected to the planet carrier, the at least one shaft rotating with the planet carrier relative to the crankshaft; and
wherein:
the at least one first planet gear is rotationally fixed to the at least one shaft;
the at least one second planet gear is rotationally fixed to the at least one shaft; and
the at least one first planet gear drives the at least one second planet gear via the at least one shaft.

13. The drive assembly of claim 1, further comprising a gear reduction assembly operatively connecting the control motor to the planet carrier.

14. The drive assembly of claim 1, further comprising a reduction transmission operatively connecting the traction motor to the crankshaft.

15. The drive assembly of claim 14, wherein the reduction transmission comprises at least one planetary gear set.

16. The drive assembly of claim 15, wherein the at least one planetary gear set comprises:
a first planetary gear set connected to and driven by the traction motor; and
a second planetary gear set operatively connected between the first planetary gear set and the crankshaft.

17. The drive assembly of claim 16, wherein:
the planet carrier is a first planet carrier;
the first planetary gear set comprises:
a third sun gear disposed about and coaxial with the crankshaft, the third sun gear rotating relative to the crankshaft, the third sun gear being connected to and driven by the traction motor;
a third ring gear disposed about and coaxial with the crankshaft;
a second planet carrier disposed about and coaxial with the crankshaft, the second planet carrier rotating relative to the crankshaft; and
at least one third planet gear rotationally connected to the second planet carrier, the at least one third planet gear rotating with the second planet carrier relative to the crankshaft, the at least one third planet gear engaging the third sun gear and the third ring gear;
the second planetary gear set comprises:
a fourth sun gear disposed about and coaxial with the crankshaft, the fourth sun gear rotating relative to the crankshaft, the fourth sun gear being connected to and driven by the second planet carrier;
a fourth ring gear disposed about and coaxial with the crankshaft;
a third planet carrier disposed about and coaxial with the crankshaft, the third planet carrier being connected to the crankshaft for driving the crankshaft; and
at least one fourth planet gear rotationally connected to the third planet carrier, the at least one fourth planet gear rotating with the third planet carrier relative to the crankshaft, the at least one fourth planet gear engaging the fourth sun gear and the fourth ring gear.

18. The drive assembly of claim 17, wherein the third ring gear and the fourth ring gear are rotationally fixed.

19. The drive assembly of claim 1, further comprising a controller for controlling power applied to the traction motor and power applied to the control motor; and
wherein the controller is configured to control the power applied to the traction motor based at least on:
a speed of rotation of the crankshaft;
a speed of rotation of the control motor; and
the power applied to the control motor.

20. A bicycle comprising:
a frame;
a front wheel rotationally connected to the frame;
a rear wheel rotationally connected to the frame;
a driven sprocket operatively connected to the rear wheel for driving the rear wheel;
the drive assembly of claim 1 connected to the frame;
a flexible drive member operatively connecting the drive sprocket to the driven sprocket; and
a battery pack electrically connected to the traction motor and to the control motor.
